(19) United States
(12) Patent Application Publication
(10) Pub. No.: US 2025/0300457 A1
(43) Pub. Date: Sep. 25, 2025

(54) MODULAR ENERGY STORAGE AND DISTRIBUTION SYSTEM

(71) Applicant: RYAN O'Leary, Warwick, NY (US)

(72) Inventor: RYAN O'Leary, Warwick, NY (US)

(73) Assignee: OZOP ENERGY SOLUTIONS, INC., Warwick, NY (US)

(21) Appl. No.: 19/074,901

(22) Filed: Mar. 10, 2025

Related U.S. Application Data
(60) Provisional application No. 63/569,293, filed on Mar. 25, 2024.

(51) Int. Cl. H02J 1/14; H01M 10/42; H01M 50/204; H01M 50/251; H01M 50/258; H02J 7/00; H02J 7/35

(52) U.S. Cl. CPC H02J 1/14; H01M 10/425; H01M 50/204; H01M 50/251; H01M 50/258; H02J 7/007; H02J 7/35; H01M 2010/4271; H01M 2220/10

(57) ABSTRACT

The present disclosure provides a modular energy storage and distribution system comprising a plurality of battery sleds. Each of the battery sleds comprises an array of battery cells, wherein the array of battery cells stores and supplies electrical energy. A microprocessor establishes a distributed network and manages operations in a master-slave configuration upon system initialization. A first battery sled assumes a master role, and subsequent battery sleds assume slave roles. A unified cable structure couples each of the battery sleds, wherein the unified cable structure comprises power supply lines and a data transmission cable. The data transmission cable facilitates communication between the at least one microprocessor of each of the battery sleds, and the unified cable structure comprises shielding to mitigate electromagnetic interference.

### CROSS-REFERENCE TO RELATED APPLICATIONS/INCORPORATION BY REFERENCE

This application claims priority to U.S. provisional application 63/569,293 titled MODULAR ENERGY STORAGE AND DISTRIBUTION filed on Mar. 25, 2024, invented by Ryan O'Leary, which is incorporated herein reference in its entirety for all purposes.

### TECHNICAL FIELD

The present disclosure generally relates to energy storage and power distribution. Further, the present disclosure particularly relates to a scalable and adaptable energy management system.

### BACKGROUND

Generally, energy storage and management has witnessed momentum in recent years due to increased demand for efficient and reliable battery systems across various industries, including automotive, renewable energy, and portable electronic devices. Conventional battery systems employ interconnected battery cells forming a unified power source. Various challenges are associated with such systems, particularly in scalability, flexibility, and efficient energy distribution. Additionally, system design complexity increases due to the necessity of managing separate power transmission and data communication channels. Such challenges limit the effectiveness, reliability, and adaptability of conventional battery systems across various applications.

Moreover, scalability and flexibility limitations associated with existing battery systems present significant challenges. Adjusting capacity or replacing degraded battery cells often necessitates substantial reconfiguration of the entire system. Such a reconfiguration process requires significant time and introduces the risk of system downtime. Such downtime is detrimental to certain applications, including electric vehicles and grid storage, where continuous and stable power availability remains essential. Conventional battery systems often utilize fixed-capacity battery arrangements, wherein expansion or reduction in energy storage capacity requires structural modifications and rewiring. Such an approach increases complexity, limits modular adaptability, and results in excessive resource consumption. Additionally, conventional battery systems employ a centralized control mechanism to manage charging, discharging, and energy allocation. Such a centralized control mechanism introduces a single point of failure, which compromises overall reliability. A failure occurring at the centralized control mechanism affects the entire energy storage system, causing operational disruptions and limiting system resilience.

Further, ineffective management of energy distribution further affects conventional battery systems. Uniform load distribution and charge balancing across all battery cells remain suboptimal in such systems. Uneven energy distribution results in certain battery cells experiencing higher charge cycles compared to others. Such an imbalance accelerates battery degradation and reduces overall lifespan. Larger systems comprising a substantial number of battery cells exacerbate such complexities. Management of energy distribution in such large-scale systems becomes increasingly difficult due to voltage fluctuations, current imbalances, and inefficient load sharing. Such factors negatively impact energy retention capacity and long-term performance of conventional battery systems. Additionally, state-of-charge mismatches among battery cells cause overcharging or deep discharging, further degrading battery efficiency and performance. In multi-unit battery configurations, conventional systems often lack mechanisms to dynamically adjust energy distribution based on individual cell conditions, further intensifying performance inconsistencies.

Additionally, power transmission and data communication remain separate in existing battery systems. Such a separation necessitates additional components and intricate wiring, increasing system bulk and complexity. Managing distinct power and data channels complicates system design, installation, and maintenance. Conventional systems often employ separate wiring harnesses for high-voltage power transmission and low-voltage data exchange, leading to increased material costs and assembly time. The presence of multiple cables introduces electromagnetic interference, causing signal degradation and communication failures. Furthermore, maintenance and troubleshooting of such systems require dedicated diagnostic procedures for power and data channels separately, thereby increasing downtime and operational inefficiencies. In high-power applications, conventional wiring methods require shielding and insulation mechanisms to prevent electrical noise, further increasing design complexity. Such constraints limit the adaptability of conventional battery systems in space-constrained environments, including portable energy storage units and electric vehicle platforms.

In light of the above discussion, there exists an urgent need for solutions that overcome the problems associated with conventional systems and techniques for energy storage, scalability, energy distribution, and combined power transmission and data communication.

### SUMMARY

In an embodiment, the present disclosure provides a modular energy storage and distribution system. A plurality of battery sleds comprises an array of battery cells, wherein the array of battery cells stores and supplies electrical energy. At least one microprocessor establishes a distributed network and manages operations in a master-slave configuration upon system initialization, wherein a first battery sled assumes a master role, and the subsequent battery sleds assume slave roles. A unified cable structure couples each of the battery sleds, wherein the unified cable structure comprises power supply lines and a data transmission cable. The data transmission cable facilitates communication between the at least one microprocessor of each of the battery sleds. The unified cable structure comprises shielding to mitigate electromagnetic interference, thereby maintaining signal integrity during energy transmission and communication.

In an embodiment, each of the battery sleds comprises an aluminum frame coated with a rubberized layer, wherein the rubberized layer enhances impact resistance and prevents structural deformation. The rubberized layer provides a cushioning effect against external mechanical shocks, thereby reducing the likelihood of damage to internal components. The aluminum frame maintains structural integrity while allowing lightweight construction to facilitate transportability and modular assembly within various configurations of the modular energy storage and distribution system.

In an embodiment, the at least one microprocessor establishes a hierarchical power control mechanism, wherein the hierarchical power control mechanism assigns priority levels to the array of battery cells based on energy storage capacity and state of charge. The hierarchical power control mechanism determines the sequence in which the array of battery cells participates in energy discharge and recharge cycles. The hierarchical power control mechanism further enables automated redistribution of charge loads to balance power supply stability.

In yet another embodiment, the at least one microprocessor executes a role rotation process, wherein the role rotation process periodically reassigns the master role among the battery sleds to balance operational wear and prolong service life. The role rotation process evaluates operational parameters such as voltage fluctuations, charge cycle history, and thermal characteristics to determine an optimal schedule for reassignment. The role rotation process thereby prevents continuous stress on a single battery sled and extends overall battery cell longevity.

In another embodiment, the at least one microprocessor manages a load-balancing mechanism, wherein the load-balancing mechanism dynamically distributes power output from the array of battery cells based on real-time consumption demand. The load-balancing mechanism calculates energy requirements of connected external loads and adjusts the distribution of electrical power accordingly.

In yet another embodiment, the at least one microprocessor executes an automated load-shedding process, wherein the automated load-shedding process selectively disconnects non-essential external loads during power shortages. The automated load-shedding process determines priority levels of connected loads based on preconfigured parameters and dynamically disconnects lower-priority loads to conserve available energy. The automated load-shedding process prevents complete energy depletion by maintaining power delivery to essential loads under constrained supply conditions.

In an embodiment, the at least one microprocessor executes an adaptive sleep mode, wherein the adaptive sleep mode selectively deactivates low-demand array of battery cells to reduce standby power consumption. The adaptive sleep mode monitors real-time energy demand and identifies batteries that do not require immediate operation, transitioning such batteries to a low-power state.

In an embodiment, each of the battery sleds comprises an expandable interlocking mechanism, wherein the expandable interlocking mechanism enables modular expansion without requiring additional structural modifications. The expandable interlocking mechanism facilitates integration of additional battery sleds into the modular energy storage and distribution system. The expandable interlocking mechanism supports rapid scalability, enabling the modular energy storage and distribution system to be adapted for increased capacity or specialized applications without necessitating reconfiguration of existing components.

In another embodiment, each of the battery sleds comprises an intelligent cycle count monitor, wherein the intelligent cycle count monitor tracks charge and discharge cycles of the array of battery cells and adjusts power output to extend battery lifespan. The intelligent cycle count monitor evaluates historical charge cycle data and implements adaptive charging schedules to prevent excessive wear. The intelligent cycle count monitor contributes to optimizing long-term efficiency and mitigating capacity degradation within the array of battery cells.

In an embodiment, the unified cable structure comprises a dynamic impedance tuning system, wherein the dynamic impedance tuning system modifies electrical resistance based on real-time load conditions. The dynamic impedance tuning system evaluates voltage fluctuations, current flow rates, and load distribution patterns to adjust impedance dynamically. The dynamic impedance tuning system prevents excessive energy dissipation and enhances efficiency in electrical power transmission across the modular energy storage and distribution system.

In an embodiment, the unified cable structure comprises a programmable conductivity matrix, wherein the programmable conductivity matrix dynamically alters electrical conductivity based on external voltage variations. The programmable conductivity matrix adjusts conductive pathways to compensate for changes in supply voltage levels, thereby preventing voltage instability and improving power transmission efficiency. The programmable conductivity matrix mitigates energy losses due to impedance mismatches in dynamic operating conditions.

In an embodiment, each of the battery sleds comprises an ultrasonic defect detection system, wherein the ultrasonic defect detection system identifies structural weaknesses within the battery sleds using high-frequency sound waves. The ultrasonic defect detection system detects material fatigue, microcracks, and failure points within the battery sled structure. The ultrasonic defect detection system enables early intervention to prevent catastrophic failures due to mechanical degradation over time.

In another embodiment, the unified cable structure comprises an infrared-responsive shielding layer, wherein the infrared-responsive shielding layer modifies thermal reflectivity properties in response to fluctuating environmental temperatures. The infrared-responsive shielding layer adapts to temperature variations by adjusting emissivity characteristics to dissipate heat efficiently. The infrared-responsive shielding layer prevents excessive temperature rise within the unified cable structure, thereby preserving operational reliability.

In an embodiment, the unified cable structure comprises an embedded graphene-coated conductor, wherein the embedded graphene-coated conductor reduces electrical resistance and enhances conductivity without increasing cable thickness. The embedded graphene-coated conductor improves charge transfer efficiency by minimizing resistive losses, thereby supporting high-performance power transmission with minimal material bulk.

In an embodiment, each of the battery sleds comprises a programmable high-frequency pulse activation circuit, wherein the programmable high-frequency pulse activation circuit stimulates electrochemical activity within the array of battery cells to improve charge retention efficiency. The programmable high-frequency pulse activation circuit prevents degradation effects such as lithium plating by periodically refreshing charge states within battery cells.

In an embodiment, each of the battery sleds comprises a quantum dot-enhanced photovoltaic recharging layer, wherein the quantum dot-enhanced photovoltaic recharging layer captures and converts ambient light into supplementary energy for recharging the array of battery cells. The quantum dot-enhanced photovoltaic recharging layer extends operational endurance by supplementing stored energy through renewable energy harvesting.

In an embodiment, the at least one microprocessor executes a real-time capacitance recalibration sequence, wherein the real-time capacitance recalibration sequence optimizes charge retention characteristics of the array of battery cells. The real-time capacitance recalibration sequence dynamically adjusts charge accumulation properties of battery cells to maintain stable voltage levels.

In an embodiment, the at least one microprocessor executes a real-time battery health monitoring routine, wherein the real-time battery health monitoring routine analyzes voltage values, current values, and temperature parameters to detect early-stage battery degradation. The real-time battery health monitoring routine provides predictive diagnostics to enable preventive maintenance interventions.

In an embodiment, the at least one microprocessor executes a grid-compliant load distribution pattern, wherein the grid-compliant load distribution pattern synchronizes power output fluctuations with external grid standards. The grid-compliant load distribution pattern stabilizes energy transfer efficiency by aligning discharge cycles with grid demand profiles.

In an embodiment, the unified cable structure comprises an automated power transmission regulation system, wherein the automated power transmission regulation system detects voltage surges and modifies electrical pathways to maintain a stable power output to an external grid. The automated power transmission regulation system prevents grid disturbances by dynamically managing power fluctuations.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIG. 1 illustrates a modular energy storage and distribution system, in accordance with various implementations of the present disclosure;

FIG. 2 illustrates a process diagram of a master-slave configuration for a modular energy storage and distribution system 100, in accordance with the embodiments of the present disclosure;

FIG. 3 illustrates a method for operating a modular energy storage and distribution system, in accordance with embodiments of the present disclosure;

FIG. 4 illustrates a side view of an inner portion of unified cable structure 108, in accordance with embodiments of the present disclosure;

FIG. 5 illustrates a process diagram depicting power distribution and data transmission within modular energy storage and distribution system 100, in accordance with embodiments of the present disclosure; and

FIG. 6 illustrates an isometric three-dimensional view of battery sled, in accordance with embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

As used herein, the term “modular energy storage and distribution system” refers to a system configured to store electrical energy and supply the electrical energy for consumption. Such a system comprises multiple interconnected components that operate together to regulate, store, and distribute power. The modular nature enables independent functional units to be assembled, removed, or replaced without affecting the overall operation of the system. The system incorporates various subsystems responsible for managing electrical energy storage, power conversion, and load distribution. The application of such a system comprises grid-level energy storage, renewable energy integration, backup power systems, and mobile power solutions. The system may be implemented in electric vehicles, industrial power backup systems, or portable energy stations.

As used herein, the term “battery sled” refers to a structural assembly that houses one or more energy storage units and facilitates modular connectivity. Such a battery sled accommodates battery cells while enabling secure attachment to adjacent battery sleds within an energy storage system. The configuration of the battery sled provides mechanical support, thermal regulation, and electrical connectivity. The housing of such a battery sled may be composed of materials such as aluminum, polymer composites, or other impact-resistant materials to enhance durability and safety. The application of the battery sled comprises integration in modular battery packs for electric vehicles, portable energy storage solutions, and scalable energy storage arrays. The battery sled may comprise additional components such as thermal management elements, safety circuits, and interlocking connectors to enable integration into a broader energy storage infrastructure.

As used herein, the term “array of battery cells” refers to a collection of multiple electrochemical energy storage units arranged to function collectively for storing and discharging electrical energy. Such an array of battery cells comprises multiple battery cells electrically connected in series or parallel to achieve a desired voltage level, current capacity, or energy density. The arrangement of the array of battery cells influences the performance characteristics such as power output, charge retention, and energy efficiency. The composition of battery cells within the array may comprise lithium-ion cells, nickel-metal hydride cells, lead-acid cells, or solid-state cells. The application of the array of battery cells comprises energy storage for electric vehicles, renewable energy storage, and power backup systems.

As used herein, the term “electrical energy” refers to the form of energy resulting from the movement of charged particles through a conductor or circuit. Such electrical energy is stored within an energy storage medium and is discharged to provide power to external loads. The characteristics of the electrical energy comprise voltage, current, and power output, which determine its usability for various applications. The generation of the electrical energy may be derived from chemical reactions in battery cells, mechanical energy conversion in generators, or photovoltaic energy conversion in solar panels. The application of such electrical energy comprises providing power for consumer electronics, automotive propulsion systems, and industrial machinery.

As used herein, the term “microprocessor” refers to an integrated circuit device configured to execute logical operations, process data, and control system functions. Such a microprocessor functions as the central processing unit responsible for managing operations, processing instructions, and regulating power distribution. The architecture of the microprocessor comprises components such as arithmetic logic units, memory registers, and control circuits that enable data processing and decision-making. The implementation of such a microprocessor may be in various electronic control units responsible for executing system-specific tasks. The application of the microprocessor comprises power management in energy storage systems, real-time monitoring of battery performance, and communication between distributed control nodes.

As used herein, the term “distributed network” refers to a communication framework where multiple interconnected devices operate collectively to execute computational or control functions. Such a distributed network enables decentralized processing, data exchange, and coordination among multiple processing units. The architecture of the distributed network may comprise peer-to-peer communication links and fault-tolerant configurations. The implementation of such a distributed network facilitates redundancy, load balancing, and scalable expansion. The application of the distributed network comprises control of modular energy storage systems, synchronization of battery units in power grids, and distributed control of smart electrical systems.

As used herein, the term “master-slave configuration” refers to a hierarchical control mechanism in which one processing unit assumes the primary control role, while additional processing units function as subordinate units executing instructions received from the primary unit. Such a master-slave configuration enables task execution, prioritized command dissemination, and coordinated operation among multiple units. The architecture of the master-slave configuration comprises a master unit responsible for decision-making, communication, and resource allocation, whereas slave units follow operational directives and report system status. The implementation of such a master-slave configuration assures regulated task execution, synchronized operation, and reduced computational load on subordinate units. The application of the master-slave configuration comprises battery management systems, automated control systems, and multi-processor computing architectures.

As used herein, the term “unified cable structure” refers to a consolidated wiring system that integrates power transmission lines and data communication pathways within a single assembly. Such a unified cable structure enables electrical energy distribution and real-time data exchange among interconnected system components. The composition of the unified cable structure comprises conductive pathways for power transmission, signal-carrying conductors for data transfer, and shielding elements for mitigating electromagnetic interference. The implementation of such a unified cable structure reduces wiring complexity, improves system reliability, and affirms consistent performance. The application of the unified cable structure comprises modular energy storage systems, high-power electrical distribution networks, and communication-integrated power transmission assemblies.

As used herein, the term “data transmission cable” refers to a communication medium that facilitates the exchange of digital or analog signals between interconnected processing units. Such a data transmission cable comprises conductive or fiber-optic pathways to carry electrical or optical signals with minimal interference. The characteristics of the data transmission cable comprise signal bandwidth, transmission speed, and shielding effectiveness, which influence data integrity and communication reliability. The composition of such a data transmission cable may comprise copper conductors, optical fibers, or hybrid signal pathways embedded within insulated sheathing. The application of the data transmission cable comprises data communication in energy storage systems, real-time monitoring in distributed control networks, and high-speed signal transmission in industrial automation.

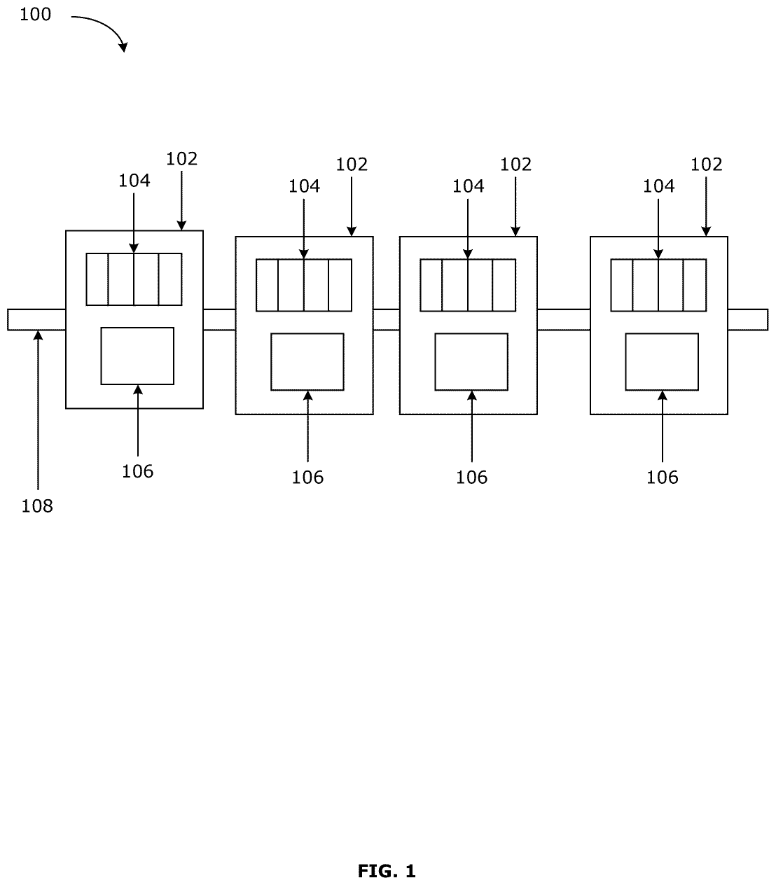

FIG. 1 illustrates a modular energy storage and distribution system 100, in accordance with various implementations of the present disclosure. The modular energy storage and distribution system 100 comprises a plurality of battery sleds 102. Each of the battery sled 102 houses an array of battery cells 104, at least one microprocessor 106, and a unified cable structure 108. The plurality of battery sleds 102 are arranged to store and distribute electrical energy efficiently. The plurality of battery sleds 102 are structurally configured to be positioned in a secure and stable manner to prevent displacement during operation. The plurality of battery sleds 102 may incorporate external enclosures formed from impact-resistant materials to provide mechanical protection. Each of the battery sled 102 may be positioned in an interlocking arrangement, enabling expansion by connecting additional battery sleds 102. Optionally, each of the battery sled 102 may comprise a temperature monitoring arrangement to detect thermal variations and prevent overheating. The plurality of battery sleds 102 may further comprise mounting interfaces to secure each of the battery sled 102 within a storage rack or housing unit. Optionally, each battery sled 102 may comprise visual indicators to display operational status. The plurality of battery sleds 102 may be selected from lithium-ion-based battery sleds 102 used in energy storage stations and electric vehicle charging stations. The plurality of battery sleds 102 enable scalability and adaptability in different energy storage applications.

In an embodiment, each of the battery sled 102 comprises an array of battery cells 104 (interchangeably referred as batteries 104 and/or battery cells 104) that store and supply electrical energy. The array of battery cells 104 comprises multiple electrochemical cells arranged in a predefined configuration to optimize energy storage capacity. The array of battery cells 104 is housed within each of the battery sled 102 and is electrically connected to deliver stored electrical energy as required. The array of battery cells 104 may be arranged in a series configuration to provide a higher output voltage or in a parallel configuration to increase current capacity. The array of battery cells 104 may further incorporate a balancing circuit to maintain uniform charge distribution across individual cells. Optionally, the array of battery cells 104 may be enclosed within a thermally conductive housing to dissipate heat and maintain operational stability. The array of battery cells 104 may comprise lithium-ion, lithium-polymer, or nickel-metal hydride cells, depending on the specific application. The array of battery cells 104 may further be encapsulated in a fire-retardant material to enhance safety. The array of battery cells 104 may comprise energy-dense lithium-ion cells used in grid storage and rechargeable nickel-metal hydride cells used in portable power applications.

In an embodiment, each of the battery sled 102 comprises at least one microprocessor 106. The at least one microprocessor 106 establishes a distributed network and manages operations within each of the battery sled 102 in a master-slave configuration upon system 100 initialization. A first battery sled 102 assumes a master role, and the subsequent battery sleds 102 assume slave roles to coordinate power distribution and communication. The at least one microprocessor 106 facilitates real-time data processing and decision-making for effective energy management. The at least one microprocessor 106 may further execute diagnostics and monitor the status of each of the battery sled 102. Optionally, the at least one microprocessor 106 may incorporate an embedded memory unit to store operational parameters and historical data for predictive analysis. The at least one microprocessor 106 may also comprise fault detection mechanisms to identify irregularities and initiate corrective actions. The at least one microprocessor 106 may operate on low-power consumption modes to optimize energy usage when not actively processing data. Optionally, the at least one microprocessor 106 may support remote firmware updates to enhance functionality. The at least one microprocessor 106 may integrate with a cloud-based monitoring system to enable remote access and control. The at least one microprocessor 106 can be selected from an ARM-based microcontroller used in energy storage systems and a RISC-V microprocessor used in distributed power management applications. The at least one microprocessor 106 enables decentralized control and enhances the operational reliability of the modular energy storage and distribution system 100.

In an embodiment, each of the battery sled 102 is coupled using a unified cable structure 108. The unified cable structure 108 comprises power supply lines and a data transmission cable. The power supply lines facilitate electrical energy transmission between each of the battery sled 102, while the data transmission cable enables communication between the at least one microprocessor 106 of each of the battery sled 102. The unified cable structure 108 is enclosed in an insulating sheath to protect against electrical hazards. The unified cable structure 108 may be flexible to accommodate various installation configurations without excessive mechanical strain. The unified cable structure 108 may further incorporate a shielding layer to mitigate electromagnetic interference and maintain signal integrity. Optionally, the unified cable structure 108 may comprise a protective conduit to prevent physical damage caused by external factors. The unified cable structure 108 may utilize industry-standard connectors for integration with external power sources and communication interfaces. Optionally, the unified cable structure 108 may comprise redundant power lines to enable continuity in case of primary circuit failure. The unified cable structure 108 may further support high-speed data transmission protocols for real-time monitoring and control.

In an embodiment, each of the battery sled 102 may comprise an aluminum frame coated with a rubberized layer, wherein the rubberized layer enhances impact resistance and prevents structural deformation. The aluminum frame provides structural support and serves as a protective enclosure for components housed within the battery sled 102. The aluminum frame is selected for lightweight properties, thermal conductivity, and corrosion resistance. The rubberized layer is applied as an external coating, forming a protective barrier against mechanical shocks, abrasions, and environmental stressors. The rubberized layer is composed of materials such as elastomer-based compounds, polyurethane coatings, or silicone-based formulations, allowing flexibility while maintaining structural integrity. The rubberized layer is applied using techniques such as dip-coating, spray application, or adhesive lamination to assure uniform coverage and adhesion to the aluminum frame. The rubberized layer acts as a vibration-dampening interface that absorbs impact forces resulting from handling, transportation, or operational conditions. The rubberized layer reduces transmission of mechanical stress to the battery sled 102, minimizing the risk of damage to internal components. The rubberized layer also provides insulation against temperature fluctuations by acting as a thermal barrier, reducing heat transfer between internal and external environments. The rubberized layer enhances grip properties to facilitate handling, installation, and maintenance without slipping.

In an embodiment, the at least one microprocessor 106 may establish a hierarchical power control mechanism, wherein the hierarchical power control mechanism assigns priority levels to the array of battery cells 104 based on an energy storage capacity and a state of charge. The hierarchical power control mechanism regulates power output by determining which array of battery cells 104 discharge first based on real-time demand and availability. The hierarchical power control mechanism dynamically adjusts charge and discharge sequences based on predefined logic, making sure energy is drawn from the most suitable source at any given moment. The hierarchical power control mechanism considers parameters such as voltage levels, discharge rates, and cycle history of individual batteries within the array of battery cells 104. The hierarchical power control mechanism prevents deep discharge of specific batteries cells 104 while evenly distributing power utilization across multiple energy storage units. The hierarchical power control mechanism incorporates real-time monitoring sensors to track power consumption trends, assuring that energy distribution is aligned with demand fluctuations. The hierarchical power control mechanism is implemented through software-based control logic executed by the at least one microprocessor 106. The hierarchical power control mechanism is adaptable for use in applications that require controlled power distribution, such as backup power systems, renewable energy storage, and electric vehicle battery management.

In an embodiment, the at least one microprocessor 106 may execute a role rotation process, wherein the role rotation process periodically reassigns the master role among the battery sleds 102 to balance operational wear and prolong service life. The role rotation process involves dynamic reassignment of control responsibilities between the battery sleds 102 based on predefined criteria. The role rotation process prevents continuous strain on a single battery sled 102 by distributing operational responsibility across multiple batteries over time. The role rotation process is initiated when parameters such as charge cycles, energy throughput, or operational duration reach a predefined threshold. The role rotation process makes sure that each battery sleds 102 experience balanced wear, preventing premature failure of individual units. The role rotation process utilizes monitoring circuits to determine when the battery sleds 102 assuming maser role has exceeded an operational limit, triggering a transition to a different battery sleds 102. The role rotation process is executed by the at least one microprocessor 106 through automated control sequences. The role rotation process is applicable in distributed energy storage applications, battery-powered mobile arrangements, and uninterruptible power supplies. The role rotation process minimizes power imbalances by periodically adjusting battery assignments based on real-time performance metrics.

In an embodiment, the at least one microprocessor 106 may manage a load-balancing mechanism, wherein the load-balancing mechanism dynamically distributes a power output from the array of battery cells 104 based on a real-time consumption demand. The load-balancing mechanism is a control process that dynamically allocates electrical power among batteries within the array of battery cells 104 to maintain a consistent power supply. The load-balancing mechanism makes sure that power demand is met by dynamically adjusting discharge rates of individual batteries within the array of battery cells 104. The load-balancing mechanism prevents overloading of any single battery by redistributing energy demand across multiple energy storage units. The load-balancing mechanism utilizes feedback from real-time voltage and current sensors to determine optimal power allocation strategies. The load-balancing mechanism accounts for fluctuations in energy demand by adjusting output levels in response to external load variations. The load-balancing mechanism prevents uneven battery depletion by affirming that energy draw is evenly distributed. The load-balancing mechanism is executed through software-based control logic embedded in the at least one microprocessor 106. The load-balancing mechanism is implemented in power backup systems, electric vehicles, and grid energy storage applications. The load-balancing mechanism enables real-time adjustments to power distribution by actively monitoring and responding to load variations.

In an embodiment, the at least one microprocessor 106 may execute an automated load-shedding process, wherein the automated load-shedding process selectively disconnects non-essential external loads during power shortages. The automated load-shedding process prioritizes essential loads by maintaining power delivery to high-priority systems while selectively disconnecting secondary loads to conserve energy. The automated load-shedding process prevents complete depletion of energy reserves by actively managing connected loads during emergency scenarios. The automated load-shedding process utilizes real-time monitoring sensors to assess power availability and load requirements. The automated load-shedding process is executed based on predefined priority levels assigned to different external loads. The automated load-shedding process is dynamically adjusted based on external conditions such as remaining energy storage levels and anticipated power restoration timelines. The automated load-shedding process is implemented in applications requiring uninterrupted power supply, including medical devices, emergency communication systems, and industrial automation networks. The automated load-shedding process is executed using relay-based switching mechanisms or software-based control logic embedded in the at least one microprocessor 106.

In an embodiment, the at least one microprocessor 106 executes an adaptive sleep mode, which enables deactivation of the arrays of battery cells 104 with low demand to reduce standby power consumption. The adaptive sleep mode analyzes real-time power demand by monitoring voltage levels, current flow, and energy consumption patterns within the modular energy storage and distribution system 100. The adaptive sleep mode utilizes data from power sensors embedded within the battery sleds 102 to determine the operational status of each array of battery cells 104. When the adaptive sleep mode identifies that certain battery cells 104 are not actively supplying power, the at least one microprocessor 106 selectively deactivates those battery cells 104 to prevent unnecessary energy drain. The adaptive sleep mode dynamically adjusts the number of active battery cells 104 based on real-time load variations and reactivates deactivated battery cells 104 when power demand increases. The adaptive sleep mode applies a predefined threshold for power fluctuations to determine when a battery cell 104 should enter or exit the sleep state. The at least one microprocessor 106 communicates with the unified cable structure 108 to coordinate the deactivation and reactivation of battery cells 104 without disrupting the overall power supply. The adaptive sleep mode prevents unnecessary charge-discharge cycles, thereby reducing wear on battery cells 104 and extending operational longevity.

In an embodiment, each of the battery sled 102 may comprise an expandable interlocking mechanism, wherein the expandable interlocking mechanism enables modular expansion without requiring additional structural modifications. The expandable interlocking mechanism comprises a series of locking grooves, sliding rails, or mechanical fasteners that allow additional battery sled 102 to be securely connected without altering the structural integrity of the existing arrangement. The expandable interlocking mechanism allows for easy scalability, supporting increased energy storage capacity based on operational requirements. The expandable interlocking mechanism is constructed from materials such as high-strength polymers, reinforced aluminum, or composite alloys to provide structural support while maintaining flexibility for future expansions. The expandable interlocking mechanism incorporates self-aligning features such as guided insertion slots or automatic latching mechanisms that enable secure attachment of additional battery sled 102. The expandable interlocking mechanism may comprise vibration-resistant components, such as rubberized buffers or elastomeric dampers, to mitigate mechanical stress and maintain stable operation during movement or installation. The expandable interlocking mechanism may comprise electrical contact interfaces that align automatically when an additional battery sled 102 is inserted, allowing for electrical connectivity without requiring external wiring modifications. The expandable interlocking mechanism supports both vertical and horizontal expansion, enabling flexible configuration layouts in different energy storage environments. The expandable interlocking mechanism allows rapid deployment of additional battery sled 102 in large-scale energy storage applications where capacity adjustments are required based on load demand. The expandable interlocking mechanism may be integrated with a locking verification system that provides mechanical feedback or an electronic signal to indicate proper engagement of additional battery sled 102.

In an embodiment, each of the battery sled 102 may comprise an intelligent cycle count monitor, wherein the intelligent cycle count monitor tracks the charge and discharge cycles of the array of battery cells 104 and adjusts a power output to extend a battery lifespan. The intelligent cycle count monitor comprises a microcontroller or embedded processing unit that continuously records the number of complete charge and discharge cycles undergone by each battery cell 104 in the array of battery cells 104. The intelligent cycle count monitor evaluates charge cycles in real-time and determines cumulative usage history to estimate the remaining operational lifespan of each battery cell. The intelligent cycle count monitor applies data-driven adjustments to charging and discharging parameters, optimizing energy flow to reduce excessive stress on battery cells 104 with higher cycle counts. The intelligent cycle count monitor integrates with thermal sensors to correlate charge-discharge patterns with temperature variations, enabling stable operation under different environmental conditions. The intelligent cycle count monitor communicates with the at least one microprocessor 106 to dynamically balance the energy load among battery cells, redistributing power supply to battery cells 104 with lower cycle counts to extend overall service life. The intelligent cycle count monitor is programmed to detect irregular charge-discharge behavior, identifying faults or degradation trends before operational failures occur. The intelligent cycle count monitor stores charge cycle data in a non-volatile memory unit, allowing historical analysis of usage patterns for predictive maintenance. The intelligent cycle count monitor applies variable charging rates based on cycle history, minimizing overcharging risks and extending operational longevity.

In an embodiment, the unified cable structure 108 may comprise a dynamic impedance tuning system, wherein the dynamic impedance tuning system modifies an electrical resistance based on real-time load conditions. The dynamic impedance tuning system comprises an array of tunable resistive elements, adjustable inductors, or reactive compensation circuits that alter electrical resistance dynamically to optimize power transfer efficiency. The dynamic impedance tuning system monitors fluctuations in electrical current, voltage, and frequency to determine required adjustments for impedance matching. The dynamic impedance tuning system comprises a feedback loop that continuously measures power transmission parameters and adjusts impedance to minimize energy losses. The dynamic impedance tuning system prevents signal distortion or excessive power dissipation by dynamically adapting to variations in load demand. The dynamic impedance tuning system integrates with voltage regulators and power distribution components within the unified cable structure 108 to maintain consistent voltage levels across different operational states. The dynamic impedance tuning system supports high-power applications requiring stable electrical resistance across varying energy loads. The dynamic impedance tuning system reduces electromagnetic interference by dynamically adjusting impedance levels to mitigate signal reflections. The dynamic impedance tuning system incorporates semiconductor-based switching elements, such as MOSFETs or IGBTs, to enable high-speed impedance adjustments in response to transient load changes.

In an embodiment, the unified cable structure 108 may comprise a programmable conductivity matrix, wherein the programmable conductivity matrix dynamically alters an electrical conductivity based on external voltage variations. The programmable conductivity matrix consists of conductive pathways embedded with variable-resistance materials, such as conductive polymers, tunable semiconductors, or liquid metal alloys, which modify electrical conductivity in response to applied control signals. The programmable conductivity matrix adjusts charge carrier density within conductive materials to regulate current flow based on detected voltage fluctuations. The programmable conductivity matrix enables real-time adjustments to resistive and conductive properties, assuring optimal power distribution across different operational states. The programmable conductivity matrix integrates with voltage sensors and real-time monitoring units that detect variations in supply voltage and apply corrective conductivity adjustments accordingly. The programmable conductivity matrix incorporates memory elements that store predefined conductivity profiles, allowing automatic recalibration based on environmental or system-based conditions. The programmable conductivity matrix prevents electrical instability by dynamically adapting conductive properties to accommodate varying power demands. The programmable conductivity matrix is compatible with direct current (DC) and alternating current (AC) applications, supporting high-frequency transmission without significant energy dissipation. The programmable conductivity matrix is embedded within the unified cable structure 108, enabling direct integration with existing power distribution networks.

In an embodiment, each of the battery sled 102 may comprise an ultrasonic defect detection system, wherein the ultrasonic defect detection system identifies structural weaknesses within each battery sled 102 using high-frequency sound waves. The ultrasonic defect detection system comprises an array of ultrasonic transducers that emit and receive high-frequency acoustic signals, which penetrate the structural layers of each battery sled 102 to detect internal anomalies. The ultrasonic defect detection system analyzes signal reflections, phase shifts, and attenuation patterns to determine the presence of defects such as material delamination, internal cracks, or structural deformations. The ultrasonic defect detection system operates at ultrasonic frequencies ranging from 1 MHz to 10 MHz, allowing detailed inspection of both surface and subsurface structural integrity. The ultrasonic defect detection system integrates with digital signal processing units that filter noise and enhance defect visualization for accurate diagnostics. The ultrasonic defect detection system may comprise phased-array ultrasonic technology, allowing multi-angle scanning to detect structural inconsistencies at different depths. The ultrasonic defect detection system is calibrated to differentiate between minor cosmetic surface imperfections and structural failures requiring intervention. The ultrasonic defect detection system allows real-time monitoring of mechanical integrity, providing continuous feedback to system control units for predictive maintenance.

In an embodiment, the unified cable structure 108 may comprise an infrared-responsive shielding layer, wherein the infrared-responsive shielding layer modifies thermal reflectivity properties in response to fluctuating environmental temperatures. The infrared-responsive shielding layer comprises a composition of thermally adaptive materials such as phase-change coatings, reflective metallic layers, or emissivity-tuned composites that adjust their optical properties based on external temperature variations. The infrared-responsive shielding layer regulates thermal absorption and dissipation characteristics by increasing reflectivity in high-temperature conditions and enhancing heat absorption in lower temperatures. The infrared-responsive shielding layer integrates with conductive substrates to form a continuous shielding layer, preventing excessive thermal buildup that could affect electrical transmission within the unified cable structure 108. The infrared-responsive shielding layer incorporates nano-scale optical elements such as photonic crystals or infrared-tuned polymers, which dynamically alter emissivity without mechanical intervention. The infrared-responsive shielding layer reduces the impact of thermal cycling effects on electrical conductivity by stabilizing internal temperature gradients across cable conductors. The infrared-responsive shielding layer supports high-power applications where temperature variations impact operational stability, including outdoor energy storage, industrial power distribution, and aerospace systems. The infrared-responsive shielding layer integrates with dielectric barrier coatings to prevent environmental contaminants from affecting its thermal modulation properties.

In an embodiment, the unified cable structure 108 may comprise an embedded graphene-coated conductor, wherein the embedded graphene-coated conductor reduces an electrical resistance and increases conductivity without increasing a cable thickness. The embedded graphene-coated conductor consists of a base conductor material, such as copper or aluminum, layered with a thin graphene-based coating to optimize charge carrier mobility. The embedded graphene-coated conductor enhances conductivity by facilitating high-speed electron transfer across a low-resistance interface. The embedded graphene-coated conductor is produced using deposition techniques such as chemical vapor deposition or solution-based processing to form an ultra-thin, uniform graphene layer. The embedded graphene-coated conductor resists oxidation and environmental degradation due to the chemical stability of graphene, preserving conductive properties over extended operational lifespans. The embedded graphene-coated conductor supports high-frequency power transmission with minimal energy loss, enabling its application in high-power energy storage and rapid-charging infrastructure. The embedded graphene-coated conductor withstands mechanical stress and bending without significant performance degradation, allowing integration into flexible and compact cable. The embedded graphene-coated conductor reduces heat generation during electrical transmission, maintaining stable temperature characteristics in continuous operation.

In an embodiment, each of the battery sled 102 may comprise a programmable high-frequency pulse activation circuit, wherein the programmable high-frequency pulse activation circuit stimulates electrochemical activity within the array of battery cells 104 to improve charge retention efficiency. The programmable high-frequency pulse activation circuit generates controlled pulse waveforms that modulate the charging and discharging characteristics of electrochemical storage cells. The programmable high-frequency pulse activation circuit comprises a signal processor that adjusts pulse frequency, amplitude, and duration based on real-time battery status. The programmable high-frequency pulse activation circuit prevents charge stratification and minimizes electrode degradation by applying optimized activation pulses at predefined intervals. The programmable high-frequency pulse activation circuit supports lithium-ion, nickel-metal hydride, and lead-acid battery chemistries, affirming compatibility with various energy storage technologies. The programmable high-frequency pulse activation circuit is integrated with charge controllers that regulate energy flow between external power sources and the array of battery cells 104. The programmable high-frequency pulse activation circuit comprises switching transistors such as MOSFETs or IGBTs that enable rapid transition between activation states. The programmable high-frequency pulse activation circuit enhances charge acceptance in batteries 104 with reduced capacity due to prolonged use by redistributing stored charge more uniformly across active material surfaces.

In an embodiment, each of the battery sled 102 may comprise a quantum dot-enhanced photovoltaic recharging layer, wherein the quantum dot-enhanced photovoltaic recharging layer captures and converts ambient light into supplementary energy for recharging the array of battery cells 104. The quantum dot-enhanced photovoltaic recharging layer consists of semiconductor nanocrystals embedded within a photovoltaic substrate, enabling high-efficiency light absorption and energy conversion. The quantum dot-enhanced photovoltaic recharging layer is tuned to specific wavelengths of ambient light, optimizing energy harvesting even under low-light conditions. The quantum dot-enhanced photovoltaic recharging layer comprises multiple bandgap materials that facilitate broad-spectrum absorption, improving energy conversion rates across varying lighting environments. The quantum dot-enhanced photovoltaic recharging layer is manufactured using solution-based processing or vapor-phase deposition techniques, forming a thin, flexible energy-harvesting layer. The quantum dot-enhanced photovoltaic recharging layer integrates with transparent protective coatings that shield active photovoltaic components from environmental exposure. The quantum dot-enhanced photovoltaic recharging layer provides continuous supplemental charging without requiring dedicated external energy sources, extending operational runtime in off-grid or portable energy storage applications. The quantum dot-enhanced photovoltaic recharging layer connects to power management circuits that regulate charge flow into the array of battery cells 104, preventing overcharging and stabilizing energy input rates.

In an embodiment, the at least one microprocessor 106 may execute a real-time capacitance recalibration sequence, wherein the real-time capacitance recalibration sequence optimizes charge retention characteristics of the array of battery cells 104. The real-time capacitance recalibration sequence measures variations in capacitance within each battery cell, adjusting charge distribution to prevent capacity imbalances. The real-time capacitance recalibration sequence comprises an impedance analysis function that detects charge accumulation inconsistencies affecting long-term battery performance. The real-time capacitance recalibration sequence applies controlled charging pulses to stabilize stored charge levels across multiple cells. The real-time capacitance recalibration sequence mitigates charge redistribution effects that lead to premature capacity loss. The real-time capacitance recalibration sequence integrates with state-of-charge monitoring systems to refine charging profiles dynamically. The real-time capacitance recalibration sequence prevents charge depletion in underutilized battery cells 104 by balancing energy transfer rates.

In an embodiment, each of the microprocessor 106 may execute a real-time battery health monitoring routine, wherein the real-time battery health monitoring routine analyzes a voltage value, a current value, and temperature parameters to detect early-stage battery degradation. The real-time battery health monitoring routine continuously records and evaluates electrical performance characteristics to identify abnormal discharge behavior. The real-time battery health monitoring routine integrates with diagnostic tools that assess internal resistance trends, enabling predictive failure detection. The real-time battery health monitoring routine determines optimal energy distribution patterns to reduce stress on aging battery cells.

In an embodiment, the at least one microprocessor 106 may execute a grid-compliant load distribution pattern, wherein the grid-compliant load distribution pattern synchronizes power output fluctuations with external grid standards. The grid-compliant load distribution pattern evaluates real-time grid conditions and modulates power delivery rates accordingly. The grid-compliant load distribution pattern prevents instability by dynamically adjusting voltage and current output based on external demand signals. The grid-compliant load distribution pattern supports integration with smart grid technologies, allowing automated load management under varying supply conditions.

In an embodiment, the unified cable structure 108 may comprise an automated power transmission regulation system, wherein the automated power transmission regulation system detects voltage surges and modifies electrical pathways to maintain a stable power output to an external grid. The automated power transmission regulation system comprises surge detection circuits that continuously monitor electrical transmission characteristics. The automated power transmission regulation system integrates with voltage regulation components that prevent excessive fluctuations affecting system stability. The automated power transmission regulation system applies automated switching mechanisms to reroute power through alternative pathways when transient surges are detected. The automated power transmission regulation system comprises programmable logic controllers that analyze historical grid performance data to optimize future power transmission adjustments. The automated power transmission regulation system prevents sudden disruptions in energy supply by dynamically compensating for transient faults in external grid connections.

The present disclosure further relates to the system as described above. Embodiments and variants disclosed above, apply mutatis mutandis to the method.

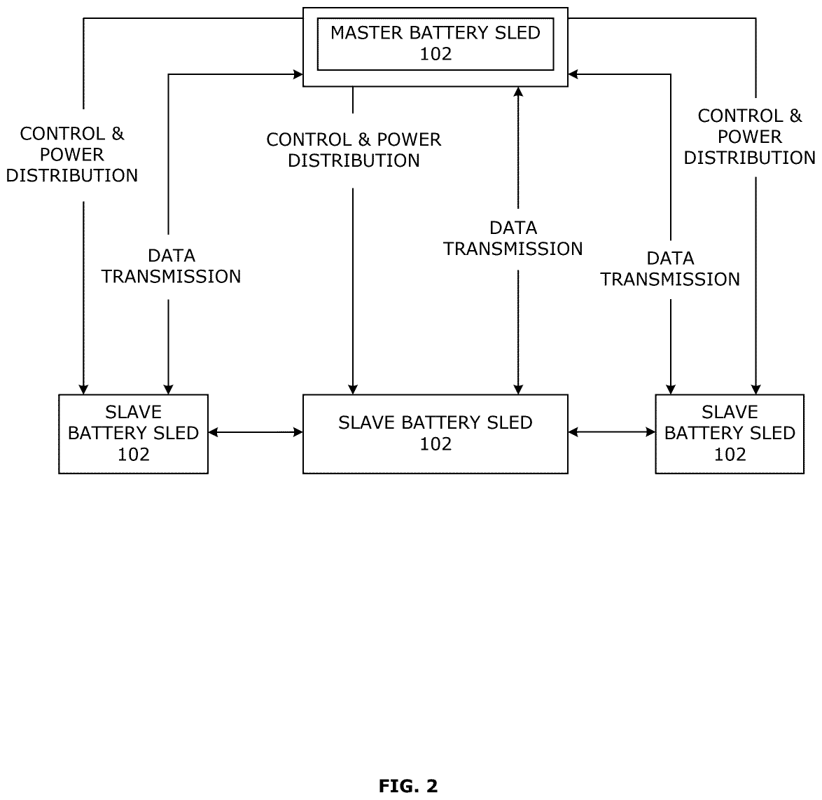

FIG. 2 illustrates a process diagram of a master-slave configuration for a modular energy storage and distribution system 100, in accordance with the embodiments of the present disclosure. Master battery sled 102 establishes control and power distribution across multiple slave battery sled 102. Master battery sled 102 receives system initialization commands and assigns control roles to each slave battery sled 102. Master battery sled 102 manages energy flow and operational synchronization by transmitting control and power distribution signals to slave battery sled 102. Slave battery sled 102 receives electrical power and operational commands from master battery sled 102 and transmits system performance data, charge status, and operational feedback. Unified cable structure 108 facilitates data transmission between master battery sled 102 and slave battery sled 102, ensuring synchronized communication and real-time adjustments. Power transmission pathways are managed through unified cable structure 108 to maintain stable energy flow between master battery sled 102 and slave battery sled 102. Microprocessor 106 within master battery sled 102 continuously monitors power requirements, allocates energy resources, and dynamically adjusts load distribution. Slave battery sled 102 responds to power allocation commands by optimizing energy usage and reporting performance metrics to master battery sled 102.

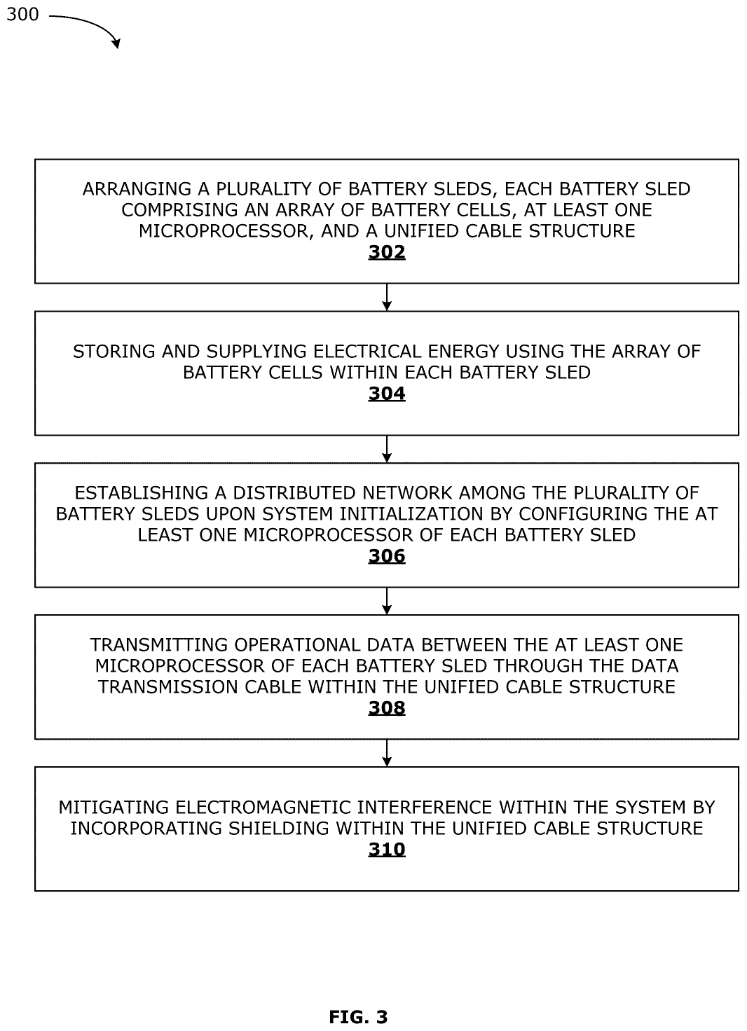

FIG. 3 illustrates a method 300 for operating a modular energy storage and distribution system, in accordance with embodiments of the present disclosure. At step 302, a plurality of battery sleds 102 is arranged in the modular energy storage and distribution system 100. Each battery sled 102 comprises an array of battery cells 104, at least one microprocessor 106, and a unified cable structure 108. The unified cable structure 108 comprises power supply lines for electrical energy transmission and a data transmission cable for communication. The arrangement of battery sleds 102 is performed to establish electrical connectivity and data communication across battery sleds 102 to enable energy storage and distribution within modular energy storage and distribution system 100. The placement of battery sleds 102 is performed in accordance with predefined system requirements to optimize space utilization and operational efficiency.

At step 304, electrical energy is stored and supplied using array of battery cells 104 within each battery sled 102. The array of battery cells 104 is charged through an external power source or a regenerative power mechanism. Once charged, array of battery cells 104 supplies electrical energy to connected devices or systems through power supply lines within unified cable structure 108. The energy storage capacity of each battery sled 102 is monitored continuously to facilitate power distribution and avoid overcharging or deep discharging conditions. The stored electrical energy is supplied based on system demand to provide a stable and uninterrupted power supply across battery sleds 102.

At step 306, a distributed network is established among battery sleds 102 upon system initialization. At least one microprocessor 106 of each battery sled 102 manages operations in a master-slave configuration, wherein a first battery sled 102 assumes a master role, and the subsequent battery sleds 102 assume slave roles. The master battery sled 102 facilitates network communication and power distribution, while slave battery sleds 102 execute instructions issued by master battery sled 102. The distributed network facilitates synchronized operation and power management within modular energy storage and distribution system 100. The master-slave arrangement is dynamically adjustable, allowing reassignment of master role in case of failure or system reconfiguration.

At step 308, operational data is transmitted between at least one microprocessor 106 of each battery sled 102 through data transmission cable within unified cable structure 108. The data transmission cable enables communication between microprocessor 106 of battery sleds 102 by facilitating exchange of control signals, performance parameters, and status updates. The data transmission process facilitates monitoring and coordination of operations of slave battery sleds 102 by master battery sled 102. The communication method employed by data transmission cable minimizes latency and facilitates system responsiveness.

At step 310, electromagnetic interference (EMI) is mitigated within modular energy storage and distribution system 100 by incorporating shielding within unified cable structure 108. The shielding reduces the impact of external electromagnetic fields on data transmission cable and power supply lines to facilitate reliable data communication and power delivery. The shielding material is selected based on conductivity, permeability, and attenuation properties to suppress EMI. The shielding within unified cable structure 108 facilitates electromagnetic compatibility (EMC) of battery sleds 102 to prevent signal distortion and facilitate stable operation of microprocessor 106 and other electronic components within modular energy storage and distribution system 100.

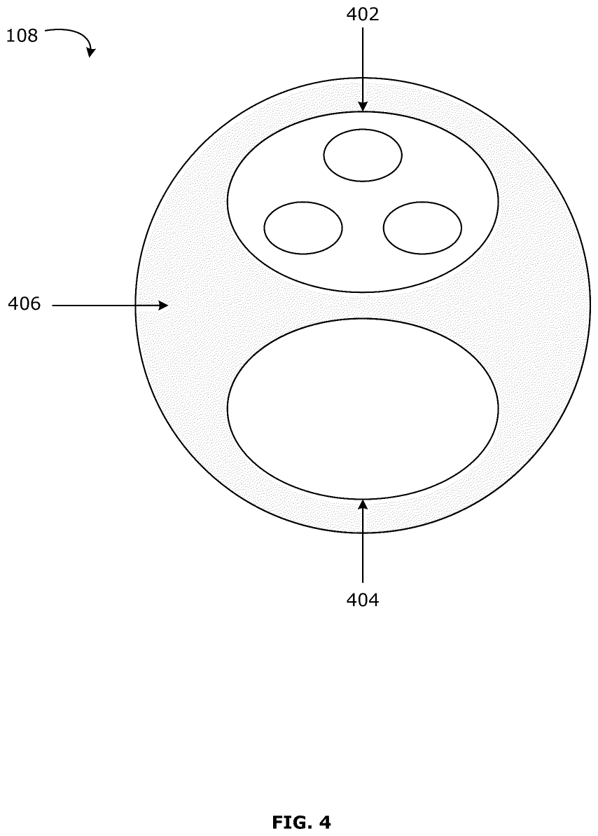

FIG. 4 illustrates a side view of an inner portion of unified cable structure 108, in accordance with embodiments of the present disclosure. Unified cable structure 108 comprises power supply lines (402), data transmission cable (404), and shielding (406). Power supply lines (402) are positioned within an enclosed section to transmit electrical energy to connected battery sleds 102. Data transmission cable (404) is positioned separately within unified cable structure 108 to facilitate communication between at least one microprocessor 106 of each battery sled 102. Shielding (406) is provided around unified cable structure 108 to mitigate electromagnetic interference (EMI), thereby maintaining signal integrity and preventing disruptions in data transmission cable (404) and power supply lines (402). Shielding (406) is composed of conductive or magnetic materials selected to reduce EMI from external sources.

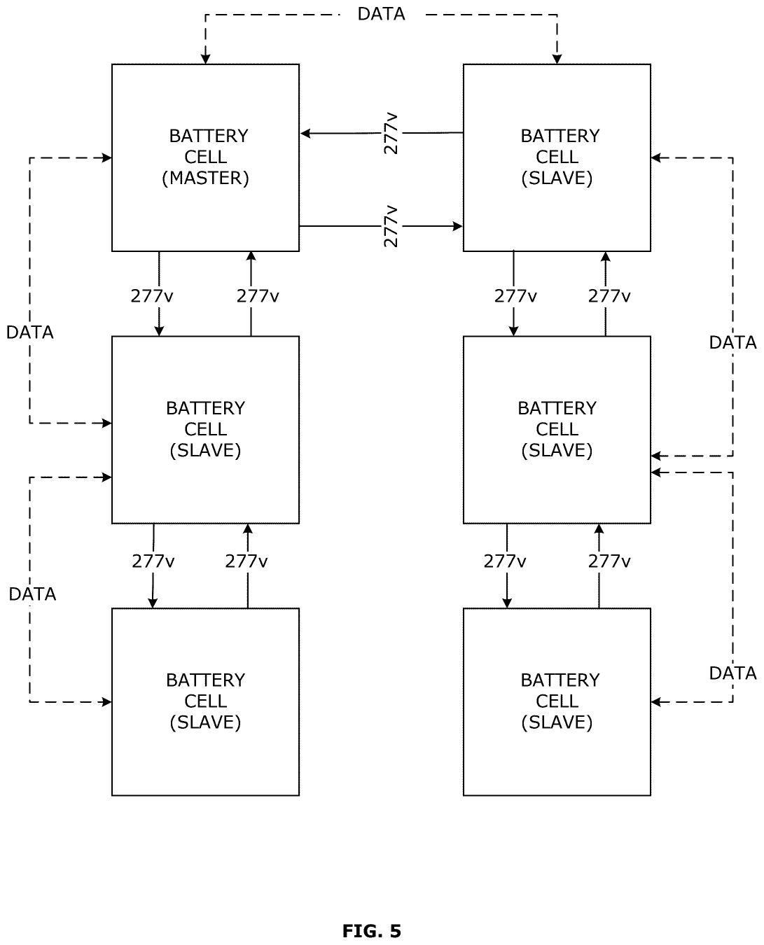

FIG. 5 illustrates a process diagram depicting power distribution and data transmission within modular energy storage and distribution system 100, in accordance with embodiments of the present disclosure. The process involves a master-slave configuration, wherein a battery sled (master) manages operations of multiple battery sleds (slave). Each battery sled (slave) is connected to battery sled (master) through data transmission paths and power supply lines. Battery sled (master) facilitates data exchange with battery sleds (slave) to synchronize energy distribution and operational parameters. Power supply lines transmit electrical energy at 277V between battery sleds (master and slave) to enable a stable power network. Data transmission paths facilitate real-time communication between battery sleds (slave) and battery sled (master) for monitoring charge levels, power flow, and performance metrics.

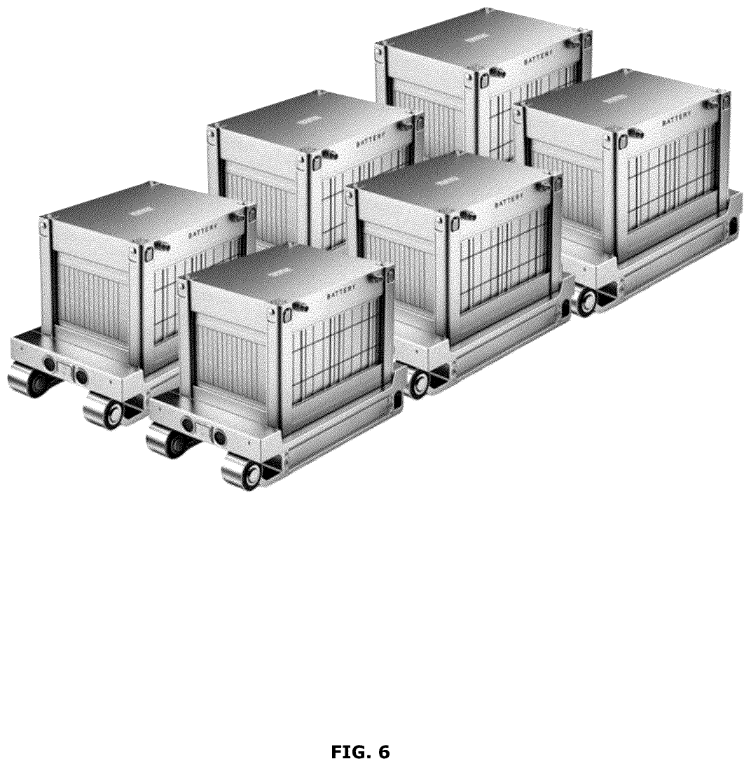

FIG. 6 illustrates an isometric three-dimensional view of battery sled 102, in accordance with embodiments of the present disclosure. Battery sled 102 comprises an array of battery cells 104 enclosed within a structural frame and positioned on a movable base with wheels. The movable base facilitates transportation and alignment within modular energy storage and distribution system 100. Battery sled 102 comprises external connectors for interfacing with unified cable structure 108 to enable power transmission and data communication. The structural frame incorporates reinforced edges and fastening components to facilitate stacking and modular arrangement of multiple battery sleds 102.

In an embodiment, the modular energy storage and distribution system 100 comprises a plurality of battery sleds 102, wherein each of the battery sled 102 comprises an array of battery cells 104, at least one microprocessor 106, and a unified cable structure 108. The array of battery cells 104 stores and supplies electrical energy to external loads. The at least one microprocessor 106 establishes a distributed network and manages operations in a master-slave configuration upon system initialization, wherein a first battery sled 102 assumes a master role and the subsequent battery sleds 102 assume slave roles. The unified cable structure 108 couples each of the battery sled 102 and comprises power supply lines and a data transmission cable, wherein the data transmission cable facilitates communication between the at least one microprocessor 106 of each of the battery sled 102. The unified cable structure 108 comprises shielding to mitigate electromagnetic interference. The array of battery cells 104 allows modular energy storage, supporting various energy capacities depending on the number and arrangement of battery cells 104. The master-slave configuration prevents uncontrolled power imbalances, as the at least one microprocessor 106 enables centralized decision-making while distributing computational and control tasks among battery sled 102. The unified cable structure 108 enables real-time synchronization of operational parameters across multiple battery sled 102, reducing response time to power demands and preventing energy distribution delays. The shielding within the unified cable structure 108 prevents signal degradation due to external electromagnetic disturbances.

In an embodiment, each of the battery sled 102 comprises an aluminum frame coated with a rubberized layer, wherein the rubberized layer enhances impact resistance and prevents structural deformation. The aluminum frame provides mechanical stability while maintaining a lightweight framework, reducing stress on supporting enclosures or transportation mechanisms. The rubberized layer absorbs mechanical shocks, minimizing the risk of cracks, deformation, or internal damage to battery sled 102 when subjected to external forces. The rubberized layer prevents surface abrasions and environmental degradation by acting as a protective barrier against moisture, dust, and chemical exposure.

In an embodiment, the at least one microprocessor 106 establishes a hierarchical power control mechanism, wherein the hierarchical power control mechanism assigns priority levels to the array of battery cells 104 based on an energy storage capacity and a state of charge. The hierarchical power control mechanism prevents uneven depletion of battery cells 104 by prioritizing usage based on available energy levels. The hierarchical power control mechanism reduces strain on individual battery cells 104 by dynamically selecting an optimal energy discharge sequence. The hierarchical power control mechanism minimizes variations in charge retention efficiency across multiple battery cells 104 by redistributing power loads in real time.

In an embodiment, the at least one microprocessor 106 executes a role rotation process, wherein the role rotation process periodically reassigns the master role among the battery sleds 102 to balance operational wear and prolong service life. The role rotation process prevents continuous strain on a single battery sled 102 by redistributing control authority among multiple battery sleds 102. The role rotation process reduces internal resistance inconsistencies by making sure that no single battery cell remains in a high-load position for extended periods. The role rotation process increases energy storage uniformity across battery sleds 104 by preventing preferential discharge cycles from occurring.

In an embodiment, the at least one microprocessor 106 manages a load-balancing mechanism, wherein the load-balancing mechanism dynamically distributes a power output from the array of battery cells 104 based on a real-time consumption demand. The load-balancing mechanism prevents overloading of individual battery cells 104 by allocating power distribution in proportion to available energy reserves. The load-balancing mechanism increases system reliability by dynamically compensating for fluctuations in energy consumption patterns. The load-balancing mechanism prevents inefficient power usage by redirecting energy flow based on monitored load variations.

In an embodiment, the at least one microprocessor 106 executes an automated load-shedding process, wherein the automated load-shedding process selectively disconnects non-essential external loads during power shortages. The automated load-shedding process preserves available energy for high-priority loads by systematically removing lower-priority connections. The automated load-shedding process prevents total energy depletion by managing power allocation in emergency conditions. The automated load-shedding process reduces energy losses associated with unnecessary power consumption.

In an embodiment, the at least one microprocessor 106 executes an adaptive sleep mode, which enables deactivation of the arrays of battery cells 104 with low demand to reduce standby power consumption. The adaptive sleep mode monitors voltage levels, discharge rates, and load requirements to identify inactive battery cells 104. The adaptive sleep mode transitions identified battery cells 104 into a low-power state and reactivates battery cells 104 when energy demand increases. The at least one microprocessor 106 communicates with unified cable structure 108 to manage energy distribution while maintaining stable voltage levels. The adaptive sleep mode reduces charge-discharge cycles, limiting degradation effects on battery cells 104.

In an embodiment, the unified cable structure 108 comprises an infrared-responsive shielding layer, wherein the infrared-responsive shielding layer modifies thermal reflectivity properties in response to fluctuating environmental temperatures. The infrared-responsive shielding layer comprises a composition of thermally adaptive materials such as phase-change coatings, reflective metallic layers, or emissivity-tuned composites that adjust their optical properties based on external temperature variations. The infrared-responsive shielding layer regulates thermal absorption and dissipation characteristics by increasing reflectivity in high-temperature conditions and enhancing heat absorption in lower temperatures. The infrared-responsive shielding layer integrates with conductive substrates to form a continuous shielding layer, preventing excessive thermal buildup that could affect electrical transmission within the unified cable structure 108.

In an embodiment, the unified cable structure 108 comprises an embedded graphene-coated conductor, wherein the embedded graphene-coated conductor reduces an electrical resistance and increases conductivity without increasing a cable thickness. The embedded graphene-coated conductor consists of a base conductor material, such as copper or aluminum, layered with a thin graphene-based coating to optimize charge carrier mobility. The embedded graphene-coated conductor enhances conductivity by facilitating high-speed electron transfer across a low-resistance interface. The embedded graphene-coated conductor resists oxidation and environmental degradation due to the chemical stability of graphene, preserving conductive properties over extended operational lifespans.

In an embodiment, the unified cable structure 108 comprises an automated power transmission regulation system, wherein the automated power transmission regulation system detects voltage surges and modifies electrical pathways to maintain a stable power output to an external grid. The automated power transmission regulation system comprises surge detection circuits that continuously monitor electrical transmission characteristics. The automated power transmission regulation system integrates with voltage regulation components that prevent excessive fluctuations affecting system stability. The automated power transmission regulation system applies automated switching mechanisms to reroute power through alternative pathways when transient surges are detected. The automated power transmission regulation system comprises programmable logic controllers that analyze historical grid performance data to optimize future power transmission adjustments.

1. A modular energy storage and distribution system, comprising:
a plurality of battery sleds, wherein each of the battery sled comprising:
an array of battery cells, wherein the array of battery cells stores and supplies an electrical energy;
at least one microprocessor, wherein the at least one microprocessor establishes a distributed network and manages the operations in a master-slave configuration upon system initialization, wherein a first battery sled is a master role, and the subsequent battery sleds are slave roles; and
a unified cable structure coupling each of the battery sled, wherein the unified cable structure comprises the power supply lines and a data transmission cable, wherein the data transmission cable facilitates communication between the at least one microprocessor of each of the battery sled, and wherein the unified cable structure comprises shielding to mitigate electromagnetic interference.

2. The modular energy storage and distribution system of claim 1, wherein each of the battery sled comprises an aluminum frame coated with a rubberized layer, wherein the rubberized layer enhances impact resistance and prevents structural deformation.

3. The modular energy storage and distribution system of claim 1, wherein the at least one microprocessor establishes a hierarchical power control mechanism, wherein the hierarchical power control mechanism assigns a priority level to the array of battery cells based on an energy storage capacity and a state of charge.

4. The modular energy storage and distribution system of claim 1, wherein the at least one microprocessor executes a role rotation process, wherein the role rotation process periodically reassigns the master role among the battery sleds to balance operational wear and prolong service life.

5. The modular energy storage and distribution system of claim 1, wherein the at least one microprocessor manages a load-balancing mechanism, wherein the load-balancing mechanism distributes a power output from the array of battery cells based on a real-time consumption demand.

6. The modular energy storage and distribution system of claim 1, wherein the at least one microprocessor executes an automated load-shedding protocol, wherein the automated load-shedding protocol selectively disconnects the non-essential external loads during the power shortages.

7. The modular energy storage and distribution system of claim 1, wherein the at least one microprocessor executes an adaptive sleep mode, which enables deactivation of the arrays of battery cells with low demand to reduce standby power consumption.

8. The modular energy storage and distribution system of claim 1, wherein each of the battery sled comprises an expandable interlocking mechanism, wherein the expandable interlocking mechanism enables modular expansion without requiring the additional structural modifications.

9. The modular energy storage and distribution system of claim 1, wherein each of the battery sled comprises an intelligent cycle count monitor, wherein the intelligent cycle count monitor tracks the charge cycles and the discharge cycles of the array of the battery cells and adjusts a power output to extend a battery lifespan.

10. The modular energy storage and distribution system of claim 1, wherein the unified cable structure comprises a dynamic impedance tuning system, to modify an electrical resistance based on the real-time load conditions.

11. The modular energy storage and distribution system of claim 1, wherein the unified cable structure comprises a programmable conductivity matrix to alter an electrical conductivity based on the external voltage variations.

12. The modular energy storage and distribution system of claim 1, wherein each of the battery sleds comprises an ultrasonic defect detection module to identify the structural weaknesses within each battery sled using the high-frequency sound waves.

13. The modular energy storage and distribution system of claim 1, wherein the unified cable structure comprises an infrared-responsive shielding layer to modify thermal reflectivity properties in response to the fluctuating environmental temperatures.

14. The modular energy storage and distribution system of claim 1, wherein the unified cable structure comprises an embedded graphene-coated conductor to reduce an electrical resistance and enhance conductivity without increasing a thickness of the unified cable structure.

15. A method for operating a modular energy storage and distribution system, the method comprising:
arranging a plurality of battery sleds, each battery sled comprising an array of battery cells, at least one microprocessor, and a unified cable structure including power the supply lines and a data transmission cable;
storing and supplying an electrical energy using the array of battery cells within each battery sled;
establishing a distributed network among the plurality of battery sleds upon system initialization by configuring the at least one microprocessor of each battery sled in a master-slave configuration, wherein a first battery sled assumes a master role and the subsequent battery sleds assume slave roles;
transmitting operational data between the at least one microprocessor of each battery sled through the data transmission cable within the unified cable structure; and
mitigating electromagnetic interference by incorporating shielding within the unified cable structure.

16. The method of claim 15, wherein the unified cable structure comprises an infrared-responsive shielding layer to modify thermal reflectivity properties in response to the fluctuating environmental temperatures.

17. The method of claim 15, wherein the unified cable structure comprises an embedded graphene-coated conductor to reduce an electrical resistance and enhance conductivity without increasing a thickness of the unified cable structure.

18. The method of claim 15, wherein each of the battery sled comprises a programmable high-frequency pulse activation circuit to stimulate electrochemical activity within the array of the battery cells to improve charge retention efficiency.

19. The method of claim 15, wherein each of the battery sled comprises a quantum dot-enhanced photovoltaic recharging layer to capture and convert ambient light into supplementary energy for recharging the array of battery cells.

20. The method of claim 15, wherein the at least one microprocessor is configured to execute a real-time capacitance recalibration sequence, to optimize the charge retention characteristics of the array of the battery cells.

21. The method of claim 15, wherein each of the microprocessor is configured to execute a real-time battery health monitoring routine to analyze a voltage value, a current value, and the temperature parameters to detect an early-stage battery degradation of each battery cell.

22. The method of claim 15, wherein the at least one microprocessor is configured to execute a grid-compliant load distribution pattern, to synchronize the power output fluctuations with the external grid standards.

23. The method of claim 15, wherein the unified cable structure comprises an automated power transmission regulation system, to detect the voltage surges and modify the electrical pathways to maintain a stable power output to an external grid.

24. A non-transitory computer-readable storage medium embodying a set of instructions, which when executed by at least one microprocessor, causes the at least one microprocessor to perform a method to operate a modular energy storage and distribution system, comprising:
arranging, a plurality of battery sleds, wherein each battery sled comprising an array of battery cells, at least one microprocessor, and a unified cable structure including power the supply lines and a data transmission cable;
storing and supplying, an electrical energy using the array of battery cells within each battery sled;
establishing, a distributed network among the plurality of battery sleds upon system initialization by configuring the at least one microprocessor of each battery sled in a master-slave configuration, wherein a first battery sled assumes a master role and the subsequent battery sleds assume slave roles;
transmitting, operational data between the at least one microprocessor of each battery sled through the data transmission cable within the unified cable structure; and
mitigating, electromagnetic interference by incorporating shielding within the unified cable structure.
